(19) United States
(12) Patent Application Publication
(10) Pub. No.: US 2006/0118697 A1
(43) Pub. Date: Jun. 8, 2006

(54) Liquid crystal display apparatus, light-sensing element and apparatus for controlling luminance of a light source

(76) Inventors: Ki-Chan Lee, Suwon-si (KR); Yun-Jae Park, Yongin-si (KR); Hyun-Seok Ko, Anseong-si (KR)

Correspondence Address: DLA PIPER RUDNICK GRAY CARY US, LLP, 2000 UNIVERSITY AVENUE, E. PALO ALTO, CA, 94303-2248, US

(21) Appl. No.: 11/297,157

(22) Filed: Dec. 7, 2005

(30) Foreign Application Priority Data
Dec. 7, 2004 (KR) 10-2004-102565
Feb. 1, 2005 (KR) 10-2005-009181

(51) Int. Cl. G01J 1/32; H01J 40/14

(52) U.S. Cl. 250/205; 250/214 R

(57) ABSTRACT

A liquid crystal display apparatus includes an LCD panel assembly. A backlight assembly includes a light source that irradiates the LCD panel assembly. A light-sensing part generates a detection signal corresponding to a quantity of the light. A reference signal-generating part generates a reference signal corresponding to a reference quantity of the light. A control signal-generating part compares the detection signal with the reference signal to generate a control signal. A backlight assembly-controlling part controls the luminance of the light source in accordance with the control signal.

### CROSS REFERENCE TO RELATED APPLICATION

This application claims priority under 35 USC § 119 to Korean Patent Application Nos. 2004-102565 filed on Dec. 7, 2004 and 2005-9181 filed on Feb. 1, 2005, the contents of which are herein incorporated by reference in their entirety for all purposes.

### BACKGROUND OF THE INVENTION

1. Field of the Invention

The present invention relates to a liquid crystal display (LCD) apparatus and a light-sensing element, more particularly, to an LCD apparatus that includes an apparatus for controlling the luminance of a light source in a backlight assembly, and a light sensing element.

2. Description of the Related Art

In general, display apparatuses are classified into an emissive type display apparatus that emits light by itself and a non-emissive type display apparatus that displays images using light from a separate light source. Examples of the emissive-type display apparatus include cathode ray tube (CRT), organic electro-luminescence display panel (OLED), a plasma display panel (PDP), etc. The non-emissive type display apparatus is a liquid crystal display (LCD) apparatus which is one of flat panel display devices, for example.

An LCD apparatus includes two substrates, for example, a color filter (CF) substrate and a thin film transistor (TFT) substrate having electrodes for generating an electric field, and an LC layer interposed between the CF and TFT substrates. When a voltage is applied to the electrodes, the electric field is generated in the LC layer. The intensity of the electric field may be adjustable by varying the voltage to control the transmissivity of light passing through the LC layer, thereby obtaining a desired image. The light may include artificial light (e.g., light from a lamp) or natural light (e.g., sunlight).

Typically, the light source of an LCD apparatus includes a plurality of lamps. The lamps include a fluorescent lamp such as an external electrode fluorescent lamp (EEFL), a cold cathode fluorescent lamp (CCFL), a light emitting diode (LED), etc.

Since the LCD apparatus which is one of the non-emissive type display apparatuses displays an image using the light emitted from a backlight assembly, the display quality of the image is determined, at least to a degree, by the luminance level of the backlight assembly. The light source of the backlight assembly may exhibit low luminance or a deviation in the luminance due to external temperature, heat generated from the backlight assembly, non-uniformity of the light, etc. The luminance deviation commonly generated in every light source deteriorates the display quality of the LCD apparatus.

One of light sources that have been increasingly developed so as to be used as the backlight assembly of an LCD apparatus is an LED. LEDs are usually used to produce a desired color by mixing the lights generated by red (R), green (G) and blue (B) LEDs, respectively. However, LEDs have generally several problems that the light efficiency of the LEDs may be abruptly altered due to heat. This abrupt alteration in light efficiency causes unbalance of colors by a sensitive reaction between the LCD apparatus and an environmental heat source.

To prevent the display quality of the LCD apparatus from being deteriorated due to the luminance deviation, the LCD apparatus is driven by an optical feedback control. The optical feedback control operates to make a color coordinate and a luminance of the light irradiated to the LCD panel compared with predetermined values. When there are differences between the color coordinate, the luminance, and the predetermined values, measures are taken to compensate for the differences.

An electrical sensor senses elements from the external environment and creates an electrical signal. Electrical sensors are classified into an active sensor and a passive sensor. Examples of the electrical sensor include an optical sensor, a pressure sensor, a magnetic sensor, a gas sensor, a contact sensor, a temperature sensor, etc.

When external light is irradiated to the optical sensor, electrical characteristics of the optical sensor vary. Examples of the optical sensor include a solar battery, a cadmium sulfide (CdS) sensor, a photodiode, a phototransistor, etc. When light impinges on a solar battery, materials in the solar battery are excited and emit electrons, thereby creating an electrical energy from the emitted electrons. When light is shined on the CdS sensor, the electrical resistance of the CdS sensor is decreased.

The photodiode and the phototransistor include a plurality of electrodes and a semiconductor layer interposed between the electrodes. When the semiconductor layer is irradiated, a channel is formed in the semiconductor layer so that an electric current flows between the electrodes. The photodiode and the phototransistor have good responsiveness. The photodiode and the phototransistor may have a thin film structure.

However, the photodiode and the phototransistor have several problems that when the photodiode and the phototransistor operate repeatedly, electrical characteristics of the photodiode and the phototransistor are change, thereby becoming unstable.

The optical feedback control system of the backlight assembly is a discrete type control system using a microcomputer. In the optical feedback control system, treatment of a signal from a sensor and generation of a control signal Vcon are accomplished by operations based on an algorithm of the optical feedback control system. Thus, the optical feedback control system is resistant to noise and provides convenience in maintenance, management and initial setup process.

However, the optical feedback control system suffers from quantization errors and decrease in operating speeds that are intrinsic to a digital control method. Due to these disadvantages, it is difficult to control the luminance of a backlight assembly precisely and rapidly using the convention optical feedback control system.

In addition, to drive an analog-digital converter for an internal processor, a central processing unit (CPU), a memory, etc. in the digital control method, more power is used than that for an analog processor and costs for manufacturing a plurality of circuits for the digital control method are increased.

### SUMMARY OF THE INVENTION

The present invention provides a liquid crystal display apparatus that is capable of reducing measurement errors with respect to the luminance of a backlight assembly, controlling the luminance of the backlight assembly in accordance with measurement result, and curtailing the cost for manufacturing the LCD apparatus.

The present invention also provides a light-sensing element and a thin film transistor having improved electrical characteristics.

A liquid crystal display apparatus in accordance with one exemplary embodiment includes an LCD panel assembly. A backlight assembly includes a light source, a light-sensing part, a reference signal-generating part, a control signal-generating part, and a backlight assembly-controlling part. The light source irradiates the LCD panel assembly. The light-sensing part generates a detection signal corresponding to a quantity of the light. The reference signal-generating part generates a reference signal corresponding to a reference quantity of the light. The control signal-generating part compares the detection signal with the reference signal to generate a control signal. The backlight assembly-controlling part controls the luminance of the light source in accordance with the control signal.

According to one exemplary embodiment, the light-sensing part and the reference signal-generating part include a common ground terminal.

The control signal-generating part may include an amplification circuit that amplifies a difference between the reference signal and the detection signal by an amplification factor to generate a differential signal, and an analog adder generates the control signal based on the differential signal and the reference signal.

The amplification circuit may include a first operational amplifier having a first inverting input terminal, a first non-inverting input terminal into which the detection signal is inputted, and a first output terminal. A second operational amplifier includes a second inverting input terminal, a second non-inverting input terminal into which the reference signal is inputted, and a second output terminal. A third operational amplifier includes a third inverting input terminal that is electrically connected to the first output terminal of the first operational amplifier, a third non-inverting input terminal that is electrically connected to the second output terminal of the second operational amplifier, and a third output terminal.

The amplification circuit may further include a first resistor electrically connected between the first inverting input terminal of the first operational amplifier and the second inverting input terminal of the second operational amplifier. A second resistor is electrically connected between the first inverting input terminal and the first output terminal of the first operational amplifier. A third resistor is electrically connected between the second non-inverting input terminal and the second output terminal of the second operational amplifier. A fourth resistor is electrically connected between the first output terminal of the first operational amplifier and the third inverting input terminal of the third operational amplifier. A fifth resistor is electrically connected between the second output terminal of the second operational amplifier and the third non-inverting input terminal of the third operational amplifier. A sixth resistor is electrically connected between the third non-inverting input terminal of the third operational amplifier and a ground. A seventh resistor is electrically connected between the third inverting input terminal and the third output terminal of the third operational amplifier.

Here, the second, third, fourth, fifth, sixth, and seventh resistors may have resistances substantially identical to each other. Also, the first resistor may have a resistance about two times that of the second to seventh resistors.

The analog adder may include a grounded non-inverting input terminal, an inverting input terminal, an output terminal, and eighth, ninth, and tenth resistors. In this case, the inverting input terminal of the analog adder is electrically connected to the third output terminal of the third operational amplifier via the eighth resistor. Also, the inverting input terminal of the analog adder is electrically connected to the second non-inverting input terminal of the second operational amplifier via the ninth resistor. The tenth resistor is electrically connected between the non-inverting input terminal and the output terminal of the analog adder.

Here, the ninth and tenth resistors may have resistances substantially identical to each other. Also, the eighth resistor may have a resistance about two times that of the ninth and tenth resistors.

The light-sensing part may be integrated with the LCD panel assembly. Also, the light-sensing part may include at least two parts that are positioned in regions of the LCD panel assembly different from each other.

The light source may include light emitting diodes. Each of the light emitting diodes may include at least one among red, green and blue light emitting diodes. Also, the light emitting diodes may emit red light, green light or blue light.

An apparatus for controlling the luminance of a light source in accordance with another exemplary embodiment includes a light-sensing part, a reference signal-generating part, a control signal-generating part, a backlight-controlling part, and a backlight-driving part. The light-sensing part generates a detection signal based on a quantity of a light emitted from the light source. The reference signal-generating part generates a reference signal that corresponds to a reference quantity of the light. The control signal-generating part compares the detection signal with the reference signal to generate a control signal. The control signal-generating part includes an amplification circuit amplifying a difference between the reference signal and the detection signal by an amplification factor to generate a differential signal, and an analog adder generating the control signal based on the differential signal and the reference signal. The backlight-controlling part controls the luminance of the light source in accordance with the control signal. A backlight-driving part provides power to the light source in accordance with controls of the backlight-controlling part.

A light-sensing element in accordance with still another exemplary embodiment includes a base substrate, a semiconductor layer, a first electrode, and a second electrode. The semiconductor layer is formed on the base substrate. The semiconductor layer includes an amorphous silicon layer that is treated with a laser beam. The first electrode is formed on a first portion of the semiconductor layer. The second electrode is formed on a second portion of the semiconductor layer. The second electrode is spaced apart from the first electrode.

A light-sensing element in accordance with still another exemplary embodiment includes a first electrode and a second electrode spaced apart from the first electrode, and an amorphous silicon layer. The amorphous silicon layer includes a first portion making contact with the first and second electrodes, and a second portion interposed between the first and second electrodes. The first and second portions have resistances different from each other.

A thin film transistor in accordance with still another exemplary embodiment includes a base substrate, a control electrode, an insulation layer, a semiconductor layer, a first electrode and a second electrode. The control electrode is formed on the base substrate. The insulation layer is formed on the control electrode. The semiconductor layer is formed on a portion of the insulation layer corresponding to the control electrode. The semiconductor layer includes an amorphous silicon layer that is treated with a laser beam. The first electrode is formed on a first portion of the semiconductor layer. The second electrode is formed on a second portion of the semiconductor layer. The second electrode is spaced apart from the first electrode.

Alternatively, the amorphous silicon layer may be treated with visible light, ultraviolet light, infrared light, etc. Also, the amorphous silicon layer may be thermally treated or may be annealed with hydrogen.

According to one exemplary embodiment, the light-sensing part may include a photodiode, a phototransistor, a photo conductor, etc.

### BRIEF DESCRIPTION OF THE DRAWINGS

The above and other features and advantages of the present invention will become more apparent by descriptions with reference to the accompanying drawings, in which:

FIG. 1 is an exploded view illustrating a liquid crystal display (LCD) apparatus in accordance with an exemplary embodiment of the present invention;

FIG. 2 is a block diagram illustrating the LCD apparatus in FIG. 1;

FIG. 3 is a block diagram illustrating an apparatus for controlling the luminance of a light source in the LCD apparatus in FIG. 1;

FIG. 4 is a circuit diagram illustrating the amplification circuit in FIG. 3;

FIG. 5 is a graph illustrating the PWM signal of the backlight-controlling part in response to the control signal Vcon of the control signal-generating part in FIG. 3;

FIG. 6 is a circuit diagram illustrating the light-sensing part comprising the light-sensing element in the LCD panel assembly;

FIG. 7 is a plan view illustrating the light-sensing element in FIG. 6;

FIG. 8 is a cross sectional view taken along line VIII-VIII′ in FIG. 7;

FIG. 9 is graphical waveforms illustrating the driving of the light-sensing part in FIG. 6;

FIG. 10 is a graph illustrating a detection signal in response to energy variations of an incident light;

FIG. 11 is a plan view illustrating a light-sensing element in accordance with another exemplary embodiment of the present invention;

FIG. 12 is a cross sectional view taken along line XII-XII′ in FIG. 11;

FIGS. 13 and 14 are cross sectional views illustrating a method of manufacturing the light-sensing element in FIG. 12;

FIG. 15 is a cross sectional view illustrating a light-sensing element in accordance with another exemplary embodiment of the present invention;

FIGS. 16 to 18 are cross sectional views illustrating a method of manufacturing the light-sensing element in FIG. 15;

FIG. 19 is a plan view illustrating a thin film transistor (TFT) in accordance with another exemplary embodiment of the present invention;

FIG. 20 is a cross sectional view taken along line XX-XX′ in FIG. 19;

FIG. 21 is a graph illustrating a measured electrical resistance of the amorphous silicon layer with respect to an irradiation time;

FIG. 22 is a graph illustrating the repeatability and stability of the amorphous silicon layer after being irradiated with a laser beam;

FIG. 23 is a graph illustrating an electrical resistance of a channel layer in the amorphous silicon layer; and

FIG. 24 is a graph illustrating the repeatability and stability of the amorphous silicon layer after being irradiated with a laser beam.

### DESCRIPTION OF EMBODIMENTS

The present invention is described more fully hereinafter with reference to the accompanying drawings that show embodiments of the invention. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

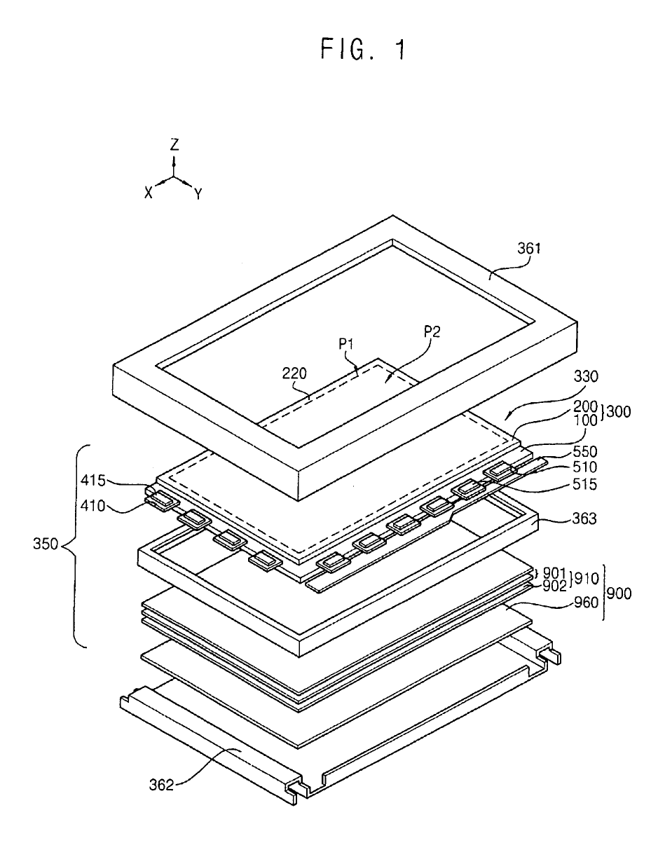

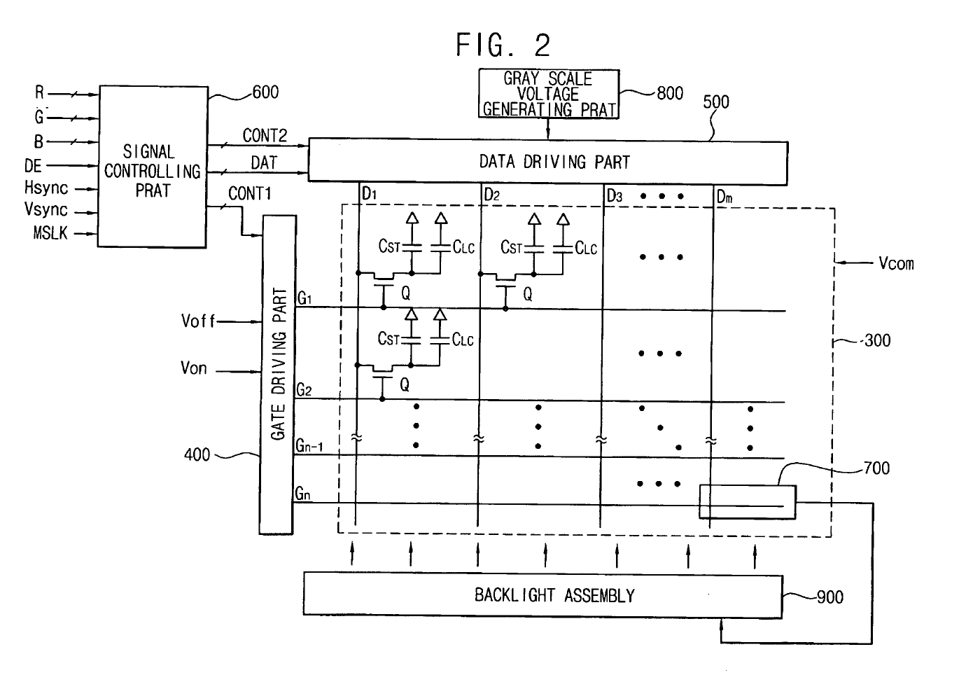

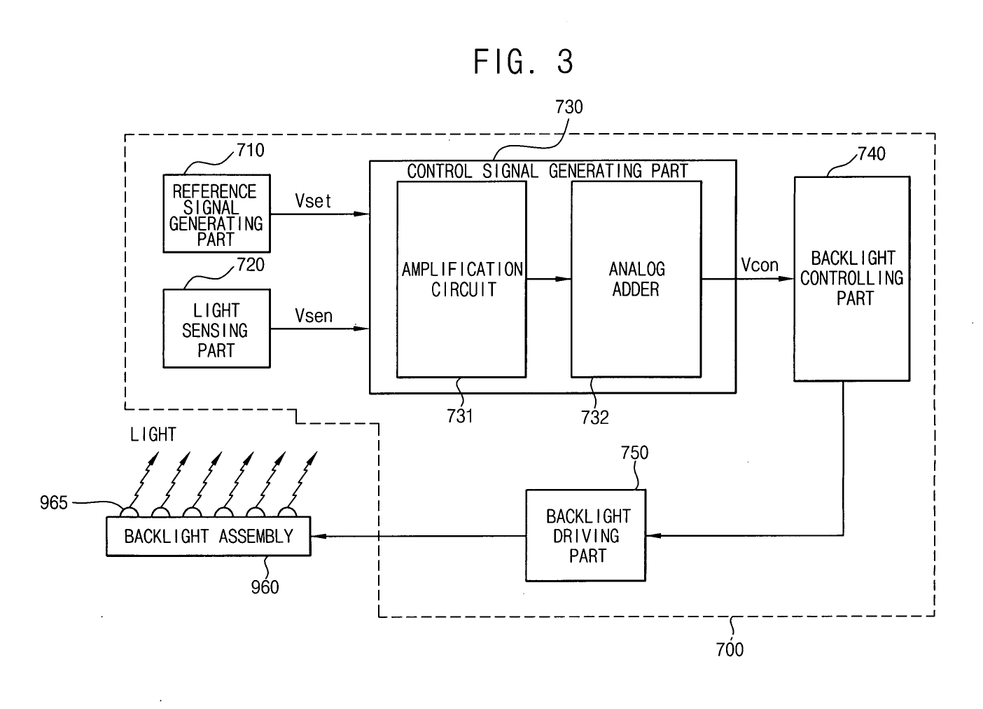

FIG. 1 is an exploded view illustrating a liquid crystal display (LCD) apparatus in accordance with an exemplary embodiment of the present invention, FIG. 2 is a block diagram illustrating the LCD apparatus in FIG. 1, and FIG. 3 is a block diagram illustrating an apparatus for controlling luminance of a light source.

Referring to FIGS. 1 and 2, the LCD apparatus 1000 includes an LCD module 350 having a display assembly 330, a mold frame 363 and a backlight assembly 900 and upper and lower chassises 361 and 362 receiving the LCD module 350.

The display assembly 330 includes an LCD panel assembly 300, a plurality of first and second tape carrier packages (TCP) 410 and 510 attached to the LCD panel assembly 300, and a printed circuit board (PCB) 550 attached to the second TCPs 510.

The LCD panel assembly 300 includes a lower substrate 100, an upper substrate 200, an LC layer (not shown) interposed between the lower and upper substrates 100 and 200, and a light-shielding layer 220 defining a display region P2.

The lower substrate 100 includes a plurality of display signal lines G₁-Gₙ and D₁-Dₘ, and a plurality of pixels that are arranged in a matrix pattern and are electrically connected to the display signal lines G₁-Gₙ and D₁-Dₘ. Most of the pixels and the display signal lines G₁-Gₙ and D₁-Dₘ are located in the display region P2.

The display signal lines G₁-Gₙ and D₁-Dₘ include a plurality of gate lines G₁-Gₙ through which gate signals (hereinafter, referred to as a scanning signal) are transmitted, and a plurality of data lines D₁-Dₘ through which data signals are transmitted. The gate lines G₁-Gₙ are parallel to one another and extend in a column direction, and the data lines D₁-Dₘ are parallel to one another and extend in a row direction. The “column direction” and the “row direction” are substantially perpendicular to each other.

Each of the pixels includes a switching element Q, such as a thin film transistor (TFT), electrically connected to each of the display signal lines G₁-Gₙ and D₁-Dₘ, and an LC capacitor C_{LC} connected to the switching element Q. Additionally, each of the pixels may include a storage capacitor C_{ST} connected to the switching element Q.

The switching element Q is provided on the lower substrate 100. The switching element Q includes a control terminal connected to the gate lines G₁-Gₙ, an input terminal connected to the data lines D₁-Dₘ, and an output terminal connected to the LC capacitor C_{LC} and the storage capacitor C_{ST}.

The LC capacitor C_{LC} has a pixel electrode (not shown) of the lower substrate 100 and a common electrode (not shown) of the upper substrate 200 as its two terminals. The LC layer interposed between the pixel electrode and the common electrode serves as a dielectric layer. The pixel electrode is coupled to the switching element Q. The common electrode to which a common voltage Vcom is applied is formed on the entire surface of the upper substrate 200.

Alternatively, the common electrode may be provided on the lower substrate 100. In this case, any one of the pixel electrode and the common electrode may have a linear shape or a rod-like shape, for example.

The storage capacitor C_{ST} serving as an auxiliary capacitor of the LC capacitor C_{LC} includes signal lines (not shown) provided on the lower substrate 100, the pixel electrode, and an insulation layer (not shown) interposed between the signal lines and the pixel electrode. A predetermined voltage such as the common voltage Vcom is applied to the signal lines. Alternatively, the storage capacitor C_{ST} may include the pixel electrode, the gate lines and the insulation layer interposed between the pixel electrode and the gate lines.

Meanwhile, to display desired colors on the LCD panel assembly 300, either one of three primary colors (R, G, B) is displayed on each pixel (hereinafter, referred to as space separation) or the three primary colors are sequentially displayed alternatively on each pixel (hereinafter, referred to as time separation), thereby being displayed the desired colors based on the operation of the time and space separations.

A polarizing plate (not shown) polarizing the light emitted from the backlight assembly 900 is attached to one of the outer and inner faces of any one of the lower and upper substrates 100 and 200.

The first TCPs 410 are attached to a first edge of the lower substrate 100. Gate-driving integrated chips 415 in a gate-driving part 400 are mounted on each of the first TCPs 410.

The second TCPs 510 are attached to a second edge of the lower substrate 100 substantially perpendicular to the first edge of the lower substrate 100. Data-driving integrated chips 515 in a data-driving part 500 are mounted on each of the second TCPs 510, respectively. The gate-driving part 400 and the data-driving part 500 are electrically connected to the gate lines G₁-Gₙ and the data lines D₁-Dₘ via signal lines (not shown) on the first and second TCPs 410 and 510, respectively.

The gate-driving part 400 applies a gate signal including a combination of gate-on voltage Von and gate-off voltage Voff to the gate lines G₁-Gₙ. The data-driving part 500 applies a data voltage to the data lines D₁-Dₘ.

Alternatively, according to a chip-on-glass (COG) mounting method, any one of the gate-driving integrated chips 415 and the data-driving integrated chips 515 may be directly mounted on the lower substrate 100 without the TCPs. The gate-driving part 400 or the data-driving part 500 may be directly formed on the LCD panel assembly 300 with the switching element Q and the display signal lines G₁-Gₙ and D₁-Dₘ.

A gray-scale voltage-generating part 800 generates first and second gray-scale voltages related to the transmissivity of the pixel. The first and second gray-scale voltages are provided to the data driver 500 as a data voltage. Here, the first gray-scale voltage has a plus value with respect to the common voltage Vcom. The second gray-scale voltage has a minus value with respect to the common voltage Vcom.

The backlight assembly 900 is assembled with the mold frame 363. The backlight assembly 900 includes a light source assembly 960 positioned under the LCD panel assembly 300, and an optical member 910 interposed between the LCD panel assembly 300 and the light source assembly 960 to treat the light emitted from the light source assembly 960.

The light source assembly 960 includes a light source such as a plurality of lamps. Examples of the lamps include a fluorescent lamp such as an external electrode fluorescent lamp (EEFL), a cold cathode fluorescent lamp (CCFL), a flat fluorescent lamp (FFL), etc. Alternatively, the light source may include a light emitting diode (LED).

Additionally, a reflection plate (not shown) may be placed under the light source assembly 960. The reflection plate reflects the light emitted from the light source assembly 960 to the LCD panel assembly 300 to improve a light efficiency.

Referring to FIGS. 2 and 3, a light-sensing part 720 is formed on an edge P1 (see FIG. 1) of the LCD panel assembly 300. The light-sensing part 720 receives the light passing through the LCD panel assembly 300 and generates a detection signal Vsen in accordance with external input signals Vin, Vsw and Vrst (see FIG. 6).

Here, the light-sensing part 720 selectively detects red (R), green (G) and blue (B) colors from an LED 965 and generates the detection signals Vsen corresponding to each of the R, G, B colors.

Hereinafter, driving operations of the LCD apparatus 1000 are illustrated in detail.

A signal-controlling part 600 receives input image signals R, G and B, and input-controlling signals controlling the input image signals R, G and B, such as a vertical synchronous signal Vsync, a horizontal synchronous signal Hsync, a main clock MCLK and a data enable signal DE. The signal-controlling part 600 processes image signals to correspond to the operation conditions of the LCD display assembly 300 in response to the input image signals R, G and B and the input-controlling signals.

The signal-controlling part 600 generates a gate-controlling signal CONT1 and a data-controlling signal CONT2. The signal-controlling part 600 outputs the gate-controlling signal CONT1 to the gate-driving part 400 and the data-controlling signal CONT2 and processed image signals DAT to the data-driving part 500.

The gate-controlling signal CONT1 includes a vertical synchronous start signal STV that orders a scanning initiation of the gate-on voltage Von, and at least one clock signal that controls an output of the gate-on voltage Von.

The data-controlling signal CONT2 includes a horizontal synchronous start signal STH that notifies transmission of data through a column of the pixel, a load signal LOAD that orders an application of a corresponding data voltage to the data signals D₁-Dₘ, a reverse signal RVS that reverses a polarity of the data voltage with respect to the common voltage Vcom (hereinafter, referred to as the polarity of the data voltage), and a data clock signal HCLK.

The data-driving part 500 receives an image data DAT with respect to a column of the pixel in accordance with the data-controlling signal from the signal-controlling part 600. The data-driving part 500 selects any one among the gray-scale voltages from the gray-scale voltage-generating part 800 corresponding to the image data DAT. The data-driving part 500 then converts the image data DAT into a corresponding data voltage. The data-driving part 500 applies the data voltage to the data lines D₁-Dₘ.

The gate-driving part 400 applies the gate-on voltage Von to the gate lines G₁-Gₙ in accordance with the gate-controlling signal CONT1 from the signal-controlling part 600 to turn on the switching element Q coupled to the gate lines G₁-Gₙ. The data voltage applied to the data lines D₁-Dₘ is applied to the corresponding pixel through the turned-on switching element Q.

A difference between the data voltage and the common voltage Vcom applied to the pixel is represented as a capacitance of the LC capacitor C_{LC}, that is, a pixel voltage. LC molecules are rearranged in response to the pixel voltage.

When a horizontal cycle corresponding to a cycle of the horizontal synchronous signal Hsync, the data enable signal DE, and a gate clock CPV is completed, the data-driving part 500 and the gate-driving part 400 repeat these operations with respect to a next row of the pixel. The gate-on voltage Von is sequentially applied to the gate lines G₁-Gₙ for one frame and the data voltages are applied to the entire pixels.

On completion of one frame, the next frame is initiated so that the reverse signal RVS applied to the data-driving part 500 is controlled to reverse the polarity of the data voltage. This is referred to as frame reversion. Here, the polarity of the data voltage that passes through one data line for one frame may be changed in response to a characteristic of the reverse signal RVS. This is referred to as column reversion. Also, the polarities of the data voltage applied to a column of the pixel may be different from each other. This is referred to as a row inversion.

An apparatus for controlling the luminance of a light source in accordance with variations of the luminance will now be described. The luminance of the light source is controlled by detecting the luminance of the light that is emitted from the backlight assembly 900 to the LCD panel assembly 300.

A light-sensing part 720 detects the light emitted from the light source 965 in the backlight assembly 960. The light-sensing part 720 generates a detection signal corresponding to a detected quantity of the light, that is, the luminance. A reference signal-generating part 710 generates a reference signal Vset. The reference signal Vset is compared with the detection signal Vsen to control the luminance of the light source. The reference signal Vset has a constant value that may be adjustable through an external device.

A control signal-generating part 730 includes an amplification circuit 731 that generates a differential signal ΔV corresponding to a difference between the detection signal Vsen from the light-sensing part 720 and the reference signal Vset from the reference signal-generating part 710, and an analog adder 732 that generates an analog control signal Vcon based on the differential signal ΔV.

The amplification circuit 731 amplifies the difference between detection signal Vsen and the reference signal Vset by an amplification factor to generate the differential signal ΔV. In the present embodiment, the amplification factor may be about two. The analog adder 732 generates the control signal Vcon based on the differential signal ΔV and the reference signal Vset. The control signal Vcon may be a signal corresponding to the difference between the reference signal Vset and a sum of the detection signal Vsen and the reference signal Vset.

A backlight-controlling part 740 controls the luminance of the light source based on the control signal Vcon. The backlight-controlling part 740 modulates the control signal Vcon to generate a pulse width modulation (PWM) signal. The backlight-controlling part 740 then transmits the PWM signal to a backlight-driving part 750. The backlight-driving part 750 generates a power provided to the light source in response to the PWM signal.

In the present embodiment, the control signal-generating part 730 includes the amplification circuit 731 and the analog adder 732. The amplification circuit 731 has an input terminal corresponding to that of the control signal-generating part 730. Also, the analog adder 732 has an output terminal corresponding to that of the control signal-generating part 730.

The amplification circuit 731 includes first, second and third operational amplifiers 810, 820 and 830 as will be later described in FIG. 4. The first operational amplifier 810 has a first non-inverting input terminal coupled to the light-sensing part 720 to receive the detection signal Vsen. The second operational amplifier 820 has a second non-inverting input terminal coupled to the reference signal-generating part 710 to receive the reference signal Vset.

Operation of the control signal generating part 730 will be now described.

FIG. 4 is a circuit diagram illustrating the control signal generating part 730 in FIG. 3.

Referring to FIG. 4, the first and second operational amplifiers 810 and 820 generate a linear combination signal of the reference signal Vset and the detection signal Vsen, and then transmits the linear combination signal to a third input terminal of the third operational amplifier 830. The third operational amplifier 830 receives the linear combination signal from the first and second operational amplifiers 810 and 820, and then amplifies the difference between the reference signal Vset and the detection signal Vsen by the amplification factor to generate the differential signal ΔV.

The first and second operational amplifiers 810 and 820 have first and second inverting input terminals (−) that are electrically connected to a common buffer resistor R1. The common buffer resistor R1 between the first and second inverting input terminals (−) reduces noise due to a voltage difference between the first and second inverting input terminals (−).

The first inverting input terminal (−) of the first operational amplifier 810 is coupled to a first output terminal of the first operational amplifier 810 via a second resistor R2. The second operational amplifier 820 has a second inverting input terminal (−) coupled to a second output terminal of the second operational amplifier 820 via a third resistor R3.

The first output terminal of the first operational amplifier 810 is electrically connected to a third inverting input terminal (−) of the third operational amplifier 830 via a fourth resistor R4. The second output terminal of the second operational amplifier 820 is coupled to the third non-inverting input terminal (+) of the third operational amplifier 830 via a fifth resistor R5. The third operational amplifier 830 has a third inverting input terminal (−) coupled to a third output terminal of the third operational amplifier 830 via a seventh resistor R7. The third non-inverting input terminal (+) of the third operational amplifier 830 is electrically connected to a sixth resistor R6, one end of which is grounded.

Hereinafter, the signal generated from the amplification circuit 731 is illustrated in detail.

Since the common buffer resistor R1 is positioned between the first and second inverting input terminals (−) of the first and second operational amplifiers 810 and 820, signals outputted from the first and second output terminals of the first and second operational amplifiers 810 and 820 are linearly combined with the detection signal inputted into the first non-inverting input terminal (+) of the first operational amplifier 810 and the second non-inverting input terminal (+) of the second operational amplifier 820. First and second output signals Vo1 and Vo2 from the first and second operational amplifiers 810 and 820 are represented by Equations 1 and 2, respectively.
Vo1=(R1+R2)Vsen/R1−R2Vset/R1 Equation 1
Vo2=(R1+R3)Vset/R1−R3Vset/R1 Equation 2

When a value R is substantially equal to R1=R2=R3=R4=R5=R6, the first and second output signals Vo1 and Vo2 are represented by Equations 3 and 4, respectively.
Vo1=(R1+R)Vsen/R1−RVset/R1 Equation 3
Vo2=(R1+R)Vset/R1−RVset/R1 Equation 4

Further, the differential signal ΔV outputted from the third output terminal of the third operational amplifier 830, which corresponds to a final output signal of the amplification circuit 731, is represented as Equation 5.
ΔV=(1+2R/R1)(Vset−Vsen) Equation 5

In Equation 5, (Vset−Vsen) corresponds to a difference between the reference signal Vset and the detection signal Vsen, and (1+2R/R1) corresponds to an amplification factor of the difference between the reference signal Vset and the detection signal Vsen.

The amplification factor of the amplification circuit 731 is a function of the common buffer resistor R1 that is coupled to the first and second inverting input terminals (−) of the first and second operational amplifier 810 and 820.

Meanwhile, an eighth resistor R8 is connected between the third output terminal of the third operational amplifier 830 and an inverting input terminal (−) of the analog adder 732. A tenth resistor R10 is coupled between the inverting input terminal (−) and an output terminal of the analog adder 732. Also, a ninth resistor R9 is electrically connected between the inverting input terminal (−) of the analog adder 732 and the second non-inverting input terminal (+) of the second operational amplifier 820. The analog adder 732 has a non-inverting input terminal (+) grounded.

The control signal Vcon outputted from the output terminal of the analog adder 732 is represented by Equation 6.
Vcon=R9(ΔV/R7+Vset/R8) Equation 6

Also, when R1 is 2R and R7 is 2R8=2R9, the control signal Vcon is represented by Equation 7.
Vcon=2Vset−Vsen=Vset+(Vset−Vsen) Equation 7

That is, the control signal Vcon outputted from the analog adder 732 corresponds to a sum of the reference signal Vset and the difference between the detection signal Vsen and the reference signal Vset.

As a result, referring back to FIG. 3, the reference signal Vset is feed-forwarded based on the detection signal Vsen detected by the light-sensing part 720 to output the control signal Vcon, which is compensated by the difference between the reference signal Vset and the detection signal Vsen, from the control signal-generating part 730.

The control signal Vcon is transmitted to the backlight-controlling part 740. The backlight-controlling part 740 includes a pulse width modulator (PWM). The PWM modulates the control signal Vcon generated from the control signal-generating part 730 and then provides the modulated control signal to a backlight-driving part 750. The backlight-driving part 750 includes a PWM type inverter. The backlight-driving part 750 controls the power provided to the light source based on the PWM signal generated from the backlight-controlling part 740.

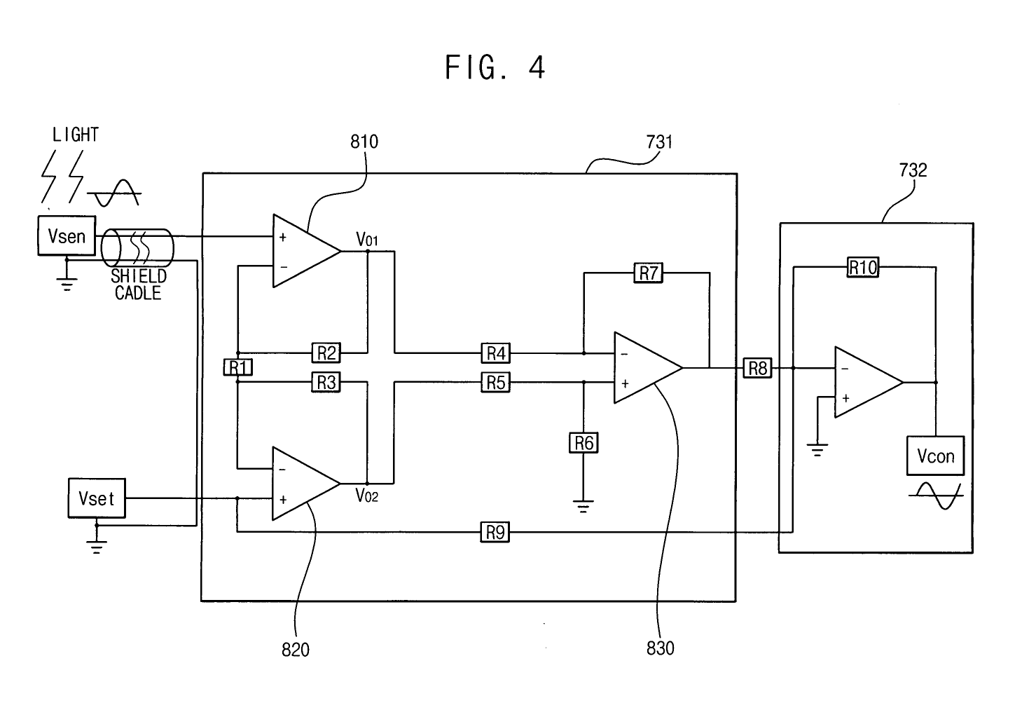

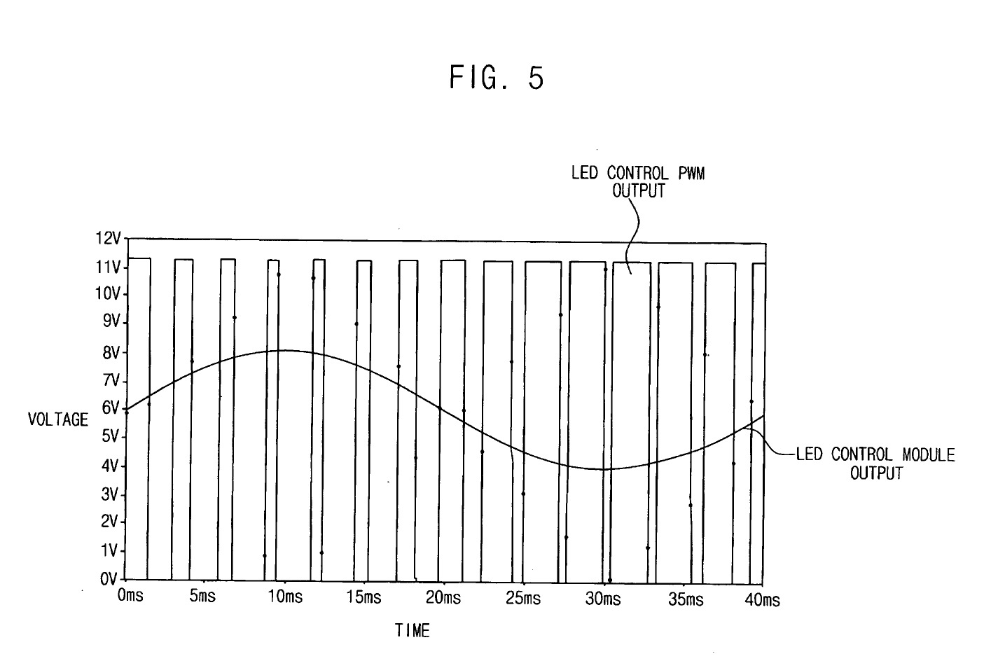

FIG. 5 is a graph illustrating the PWM signal of the backlight-controlling part 740 in accordance with the control signal Vcon of the control signal-generating part 730.

Referring to FIG. 5, it should be noted that the higher the level of the control signal is, that is, the greater the difference between the reference signal Vset and the detection signal Vsen is and the wider the width of the PWM signal applied to a driver such as an inverter is.

Referring back to FIGS. 1 and 3, alternatively, the light source of the backlight assembly 960 may include a plurality of LEDs 965. The LEDs 965 may include three primary colors having a red color R, a green color G and a blue color B. The LEDs 965 may regularly be arranged in the light source assembly 960 in a matrix pattern.

When the LEDs 965 are used as the light source, the optical member 910 is interposed between the LCD panel assembly 300 and the light source assembly 960. The optical member 910 includes a light-guiding plate 902 that mixes the red, green and blue lights from each of the LEDs 965 with each other to direct the mixed light to the LCD panel assembly 300, and optical sheets 901 that provides uniformity to the mixed light. Alternatively, a light-diffusing plate may be substituted for the light-guiding plate 902. Further, the optical member 910 may include both the light-guiding plate 902 and the light-diffusing plate.

When the LEDs, for example, R, G, B LEDs are used as the light source, separately controlling each of the LEDs is required, because each of the R, G, B LEDs has temperature dependences different from each other. Thus, the light-sensing part 720 is separately provided corresponding to wavelengths of the lights emitted from the R, G, B LEDs. Also, the light-sensing part 720 includes the control signal-generating part 730 and the backlight-controlling part 740.

Also, the reference signal Vset may vary in accordance with the colors of the light source 965. Thus, the reference signal-generating part 710 may be separately provided by the colors of the light source 965. The light-sensing part 720 may be integrated with the LCD panel assembly 300.

Since the luminance of the R, G, B LEDs is separately controlled in one exemplary embodiment, deviation of color coordination caused by the temperature dependence on part of the colors of the light source may be reduced. As a result, luminance uniformity of the light irradiating the LCD panel assembly 300 may be achieved.

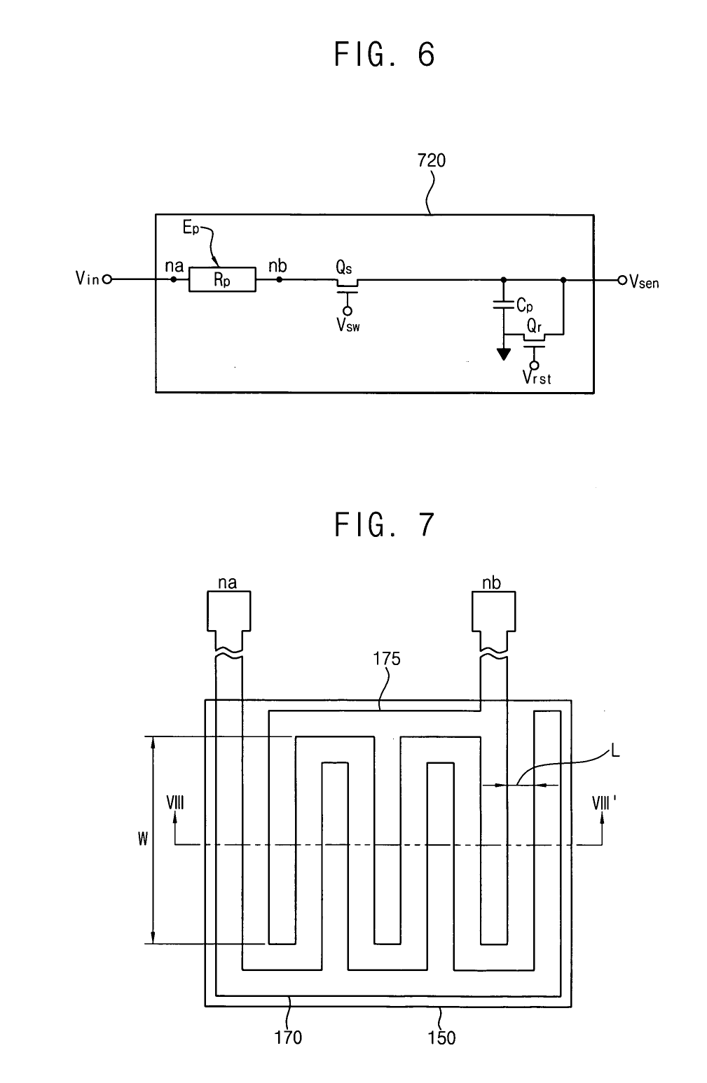

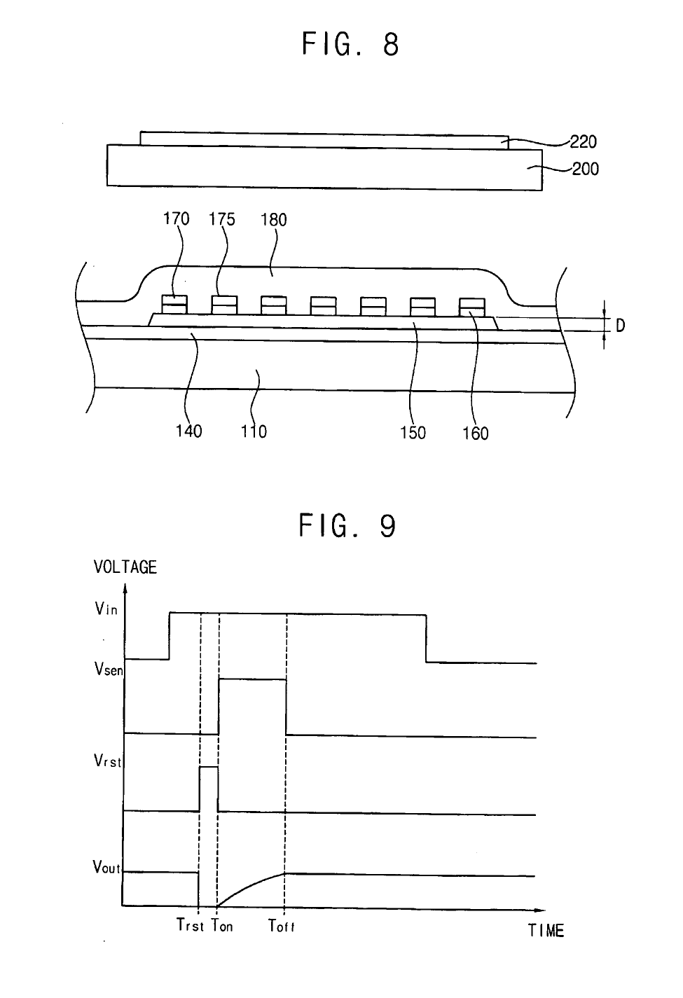

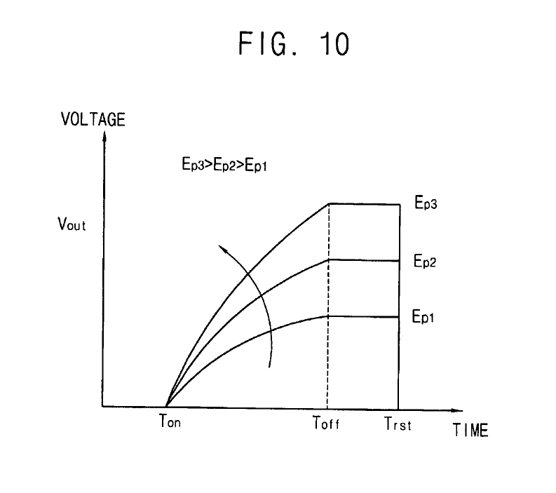

FIG. 6 is a circuit diagram illustrating the light-sensing part 720 in the LCD panel assembly 300, FIG. 7 is a plan view illustrating the light-sensing element in FIG. 6, FIG. 8 is a cross sectional view taken along line VIII-VIII′ in FIG. 7, FIG. 9 is a timing chart illustrating driving of the light-sensing part 720, and FIG. 10 is a graph illustrating the detection signal in response to energy of incident light.

Referring to FIG. 6, the light-sensing part 720 includes light-sensing element (for instance, a photo sensor) Rp, two switching elements Qs and Qr, and a detection capacitor Cp.

The light-sensing element Rp includes an input terminal na to which an input voltage Vin is applied, and an output terminal nb coupled to the switching element Qs. An electric current that correlates with an external photo energy Ep is outputted from the output terminal nb. The light-sensing element Rp includes a photo resistor having a resistance that varies when the photo resistor receives the photo energy Ep.

The switching element Qs includes an input terminal connected to the light-sensing element Rp, a control terminal into which a switching signal Vsw is input, and an output terminal connected to the detection capacitor Cp. The switching element Qs is turned on or turned off in response to the switching signal Vsw inputted into the control terminal to output the electric current from the light-sensing element Rp through the output terminal.

The detection capacitor Cp includes a first end electrically connected to the switching element Qs, and a second end grounded. The detection capacitor Cp outputs a voltage, which is charged using the electric current from the light-sensing element Rp through the switching element Qs, to which the detection signal Vsen is applied.

The switching element Qr includes a control terminal into which a reset signal Vrst is inputted, and input and output terminals electrically connected to both ends of the detection capacitor Cp. The switching element Qr is turned on or turned off in response to the reset signal Vrst to discharge the voltage in the detection capacitor Cp.

Referring to FIGS. 7 and 8, the lower substrate 100 (see FIG. 1) of the LCD panel assembly 300 (see FIG. 1) in which the light-sensing element Rp is provided includes an insulation substrate 110 and a gate insulation layer 140 including silicon nitride formed on the insulation substrate 110.

A semiconductor 150 containing hydrogenated amorphous silicon is formed on the insulation layer 140. Here, the semiconductor 150 may have a quadrangular shape. The semiconductor 150 has edges that are inclined at an angle of about 30° to about 80° with respect to the gate insulation layer 140.

Ohmic contacts 160 are formed on the semiconductor 150. Here, the ohmic contacts 160 may include, for example, silicide, N⁺-type hydrogenated amorphous silicon highly doped with N-type impurities, etc.

First electrodes 170 to which the input voltage Vin is applied and second electrodes 175 that output the electric current in response to the photo energy Ep are formed on the ohmic contacts 160. The first and second electrodes 170 and 175 are separately arranged in a comb-like shape. To readily allow the first and second electrodes 170 and 175 to make contact with other electrical elements, the first and second electrodes 170 and 175 include ends having large areas.

A passivation layer 180 is formed on the first and second electrodes 170 and 175, the insulation layer 140 and an exposed portion of the semiconductor 150. Examples of the passivation layer 180 include an organic material having good planarization characteristic and photosensitivity, amorphous silicon carbon oxide (a-Si:C:O), amorphous silicon oxyfluoride (a-Si:O:F), etc. The passivation layer 180 including amorphous silicon carbon oxide or amorphous silicon oxyfluoride may be formed by a plasma enhanced chemical vapor deposition (PECVD) process.

Alternatively, the first and second electrodes 170 and 175 may be formed beneath the semiconductor 150. The first and second electrodes 170 and 175 may be also formed on upper and lower faces of the semiconductor 150.

A light-shielding layer 220 is formed on the upper substrate 200. The light-shielding layer 220 covers the photo sensor Rp to shield light coming from an external source.

When the photo sensor Rp is directly provided to the LCD panel assembly 300, the photo sensor Rp receives the light from the backlight assembly 900 without error and has a widened light-receiving area.

Here, the resistance R of the light-sensing element Rp in accordance with the photo energy Ep of the incident light is determined in accordance with a thickness D of the semiconductor 150, an interval W between the electrodes 170 and 175, and a length of the first and second electrodes 170 and 175. The photo energy Ep is represented by Equation 8. The number (n) of electrons and holes, which are generated in irradiating the LCD panel assembly 300 with light having photo energy Ep, is represented by Equation 9.
Ep=(E/E_{λ})² Equation 8

In Equation 8, where E p indicates a relative energy of the incident light, E represents the energy of the incident light, and E_{λ} indicates the photon energy of the incident light.
n={(1−r)Ep}² Equation 9

In Equation 9, where r indicates reflectivity. Meanwhile, r is determined in accordance with the properties and surface conditions of the insulation substrate 110 and the insulation layer 140 without considering the photo energy absorbed in the insulation substrate 110 and the insulation layer 140.

Also, considering structures of the electrodes, a conductivity a of the photo sensor Rp is represented by Equation 10.
σ=[{q(μₙ+μₚ)(1−r)Ep}/WDL]² Equation 10

In Equation 10, where μₙ indicates mobility of the electrons, and μₚ represents mobility of the holes. It shall be noted that the conductivity σ of the light-sensing element Rp is in direct proportion to the photo energy Ep.

As a result, the resistance R of the light-sensing element Rp is represented by Equation 11.
R=L/WDσ=L²/{q(μₙ+μₚ)(1−r)Ep}² Equation 11

Sensitivity of the light-sensing element Rp may be calculated by adjusting the thickness D of the semiconductor 150, the interval W between the electrodes 170 and 175, and the length of the first and second electrodes 170 and 175.

The switching elements Qs and Qr and the detection capacitor Cp are directly provided to the LCD panel assembly 300 together with the light-sensing element Rp. Thus, when the detection signal is processed outside of the LCD panel assembly 300, noise level is reduced.

Hereinafter, operations of the light-sensing part 720 are illustrated in detail with reference to FIGS. 6, 9 and 10.

The input voltage Vin is maintained at a high level in the detection of the light-sensing part 720.

When the reset signal Vrst is at a high level at time Trst, the switching element Qr is turned on. Thus, the detection signal Vsen stored in the detection capacitor Cp is discharged.

When the reset signal Vrst is at a low level at time Ton, the switching element Qr is turned off. Also, when the switching signal Vsw is at a high level, the switching element Qs is turned on. In this case, the light-sensing element Rp outputs an electric current based on the resistance that is in inverse proportion to the quantity of the incident light. This current charges the detection capacitor Cp so that the detection capacitor Cp generates the detection signal Vsen. The detection signal Vsen is increased proportionally to an increase of the photo energy Ep in regular sequence of Ep₁, Ep₂ and Ep₃.

When the switching signal Vsw is at a low level at time Toff, the switching element Qs is turned off. In this case, the photo sensor Rp does not output the electric current in response to the photo energy Ep, and the detection signal Vsen stored in the detection capacitor Cp is maintained. As a result, the quantity of the light emitted from the backlight assembly 900 is obtained from recognizing the detection signal Vsen. The above-mentioned operations are periodically repeated to accurately measure the quantity of the light emitted from the backlight assembly 900.

Here, the input voltage Vin, the switching signal Vsw and the reset signal Vrst may be provided from one or more external sources. Also, the input voltage Vin, the switching signal Vsw and the reset signal Vrst may be obtained using a voltage for driving the LCD apparatus and a gate signal.

In general, when the photo sensor Rp is irradiated, the electric current continuously flows through the photo sensor Rp so that dangling bonds are formed in the semiconductor 150 and the number of excited carriers increases. After a predetermined time is lapsed, the dangling bonds join with each other so that the conductivity of the photo sensor Rp is reduced. In this embodiment, since the electric current flows through the photo sensor Rp for only a short time, reduction in the conductivity of the photo sensor Rp may be suppressed.

Also, the LCD apparatus of the present embodiment may include red (R), green (G) and blue (B) light-sensing parts 720. Each of the light sensing parts 720 generates a detection signal Vsen corresponding to the red, green and blue lights, respectively.

Further, each of the light-sensing parts 720 may be positioned on different edges P1 (see FIG. 1) of the LCD panel assembly 300. Thus, the quantity of the light emitted from the backlight assembly 900 in upward, downward, left and right directions is measured so that measurement errors of the quantity of the light at various positions are reduced. As a result, the backlight assembly 900 may be precisely controlled based on the measured quantity of the light.

In the present embodiment, the emissive type LCD apparatus is illustrated in detail, but alternatively, a non-emissive type LCD apparatus may be used.

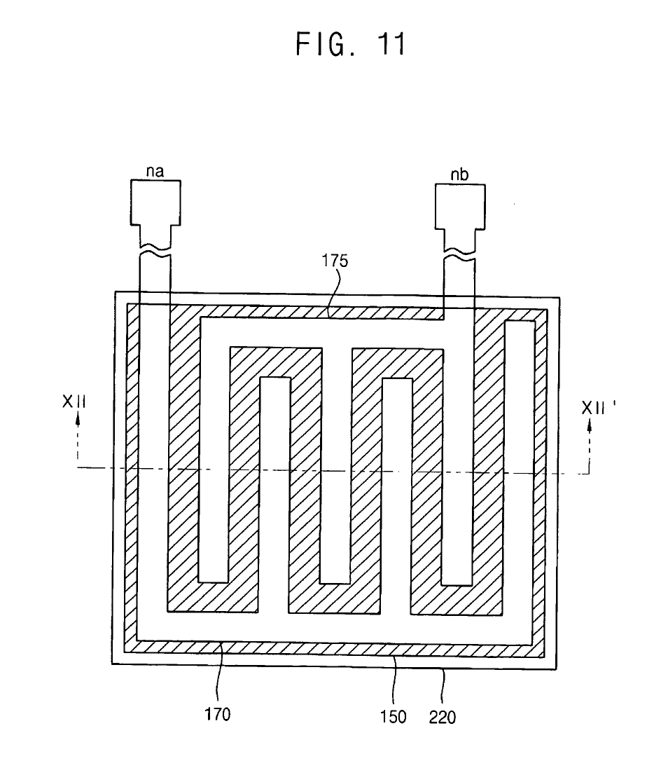

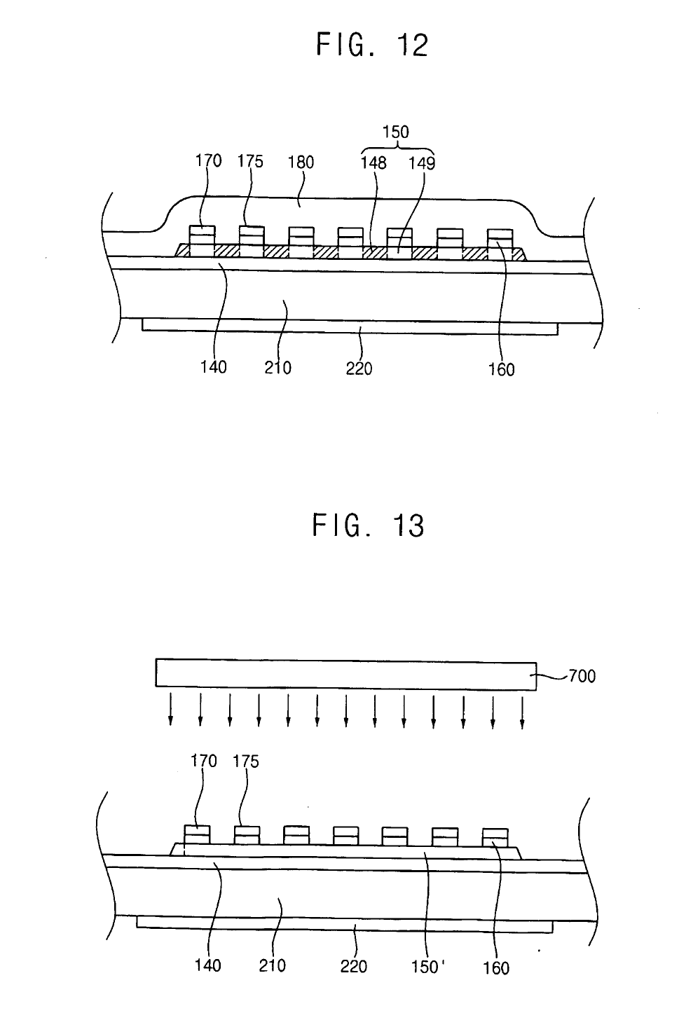

FIG. 11 is a plan view illustrating a light-sensing element Rp in accordance with an exemplary embodiment of the present invention, and FIG. 12 is a cross sectional view taken along line XII-XII′ in FIG. 11.

Referring to FIGS. 11 and 12, a light-sensing element Rp may include a base substrate 210, an insulation layer 140, a semiconductor layer 150, an ohmic contact layer 160, a first electrode 170, a second electrode 175, a passivation layer 180 and a light-shielding layer 220.

Examples of the base substrate 210 include glass, triacetylcellulose (TAC), polycarbonate (PC), polyethersulfone (PES), polyethyleneterephthalate (PET), polyethylenenaphthalate (PEN), polyvinylalcohol (PVA), polymethylmethacrylate (PMMA), cyclo-olefin polymer (COP), etc. These can be used alone or in a combination thereof.

The insulation layer 140 may be formed on the base substrate 210. Examples of the insulation layer 140 may include silicon oxide, silicon nitride, etc. These can be used alone or in a combination thereof. Additionally, the insulation layer 140 may further include an opaque insulation material such as paints and a dye. When the insulation layer 140 includes the opaque insulation material, the light-shielding layer 220 may be omitted.

The semiconductor layer 150 is formed on the insulation layer 140. The semiconductor layer 150 includes a first amorphous silicon layer 148 saturated with light and a second amorphous silicon layer 149 that is not irradiated. The first amorphous silicon layer 148 is interposed between the first and second electrodes 170 and 175. The second amorphous silicon layer 149 is positioned beneath the first and second electrodes 170 and 175. Here, amorphous silicon may be formed at a temperature lower than that for forming polysilicon and also may have good photoreactivity. In the present embodiment, the first amorphous silicon layer 148 includes hydrogenated amorphous silicon.

When amorphous silicon is irradiated, electrical characteristics of amorphous silicon change in response to the irradiation. That is, molecules in amorphous silicon are excited to create carriers, for example, electrons or holes, in the semiconductor layer 150. The carriers pass through a channel in the semiconductor layer 150 so that an electric current flows between the first and second electrodes 170 and 175.

However, since some of the molecules in amorphous silicon form unstable bonds with each other, the carriers react with the unstable molecules to form dangling bonds. Thus, the carriers are trapped in the molecules of amorphous silicon so that the electric conductivity of the semiconductor layer 150 is decreased. As a result, the electrical characteristics of the semiconductor layer 150 are altered.

To prevent the formation of dangling bonds in the semiconductor layer 150, the semiconductor layer 150 is treated with light or heat. In the present embodiment, before operating the light-sensing element Rp, the semiconductor layer 150 is treated with laser to saturate the semiconductor layer 150 with light. In this way, the dangling bonds are formed before operating the light-sensing element Rp so as not to be formed during the operation of the light-sensing element Rp.

Since a laser beam has energy higher than that of light emitted from a CCFL, the semiconductor layer 150 may be saturated with light for a short time. Here, to prevent amorphous silicon from being converted into polysilicon (referred to as phase transformation), the intensity of the laser beam is carefully controlled. An alternative way to prevent the formation of the dangling bonds entails a thermal treatment of the semiconductor layer 150. Also, the semiconductor layer 150 may be annealed using hydrogen.

In the present embodiment, the first amorphous silicon layer 148 is interposed between the first and second electrodes 170 and 175. Also, the second amorphous silicon layer 149 is positioned beneath the first and second electrodes 170 and 175. The semiconductor layer 150 may be directly formed on the base substrate 110 without formation of the insulation layer 140.

The ohmic contact layer 160 is formed on the semiconductor layer 150. The ohmic contact layer 160 may be formed by doping amorphous silicon with N⁺-type impurities. In the present embodiment, the ohmic contact layer 160 has a shape substantially identical to that of the first and second electrodes 170 and 175. The semiconductor layer 150 has edges that are inclined at an angle of about 30° to about 80° with respect to the base substrate 110.

The first and second electrodes 170 and 175 are placed on the ohmic contact layer 160. The first and second electrodes 170 and 175 are spaced apart from each other and arranged in an alternating manner. As shown in FIG. 11, the first and second electrodes 170 and 175 include ends na and nb, each of which has an area larger than that of the remaining portions of the first and second electrodes 170 and 175.

Additionally, the first and second electrodes 170 and 175 may further include a transparent conductive material such as indium tin oxide, indium zinc oxide, etc. When the first and second electrodes 170 and 175 include the transparent conductive material, the first amorphous silicon layer 148 is positioned beneath the first and second electrodes 170 and 175 as well as spaces between the first and second electrodes 170 and 175. Also, the first and second electrodes 170 and 175 may be located beneath the semiconductor layer 150.

The passivation layer 180 is formed on the insulation layer 140, the semiconductor layer 150, the ohmic contact layer 160, and the first and second electrodes 170 and 175. The passivation layer 180 protects the semiconductor layer 150, the ohmic contact layer 160 and the first and second electrodes 170 and 175 from external impact and foreign substances. The passivation layer 180 may include a transparent material.

The light-shielding layer 220 is positioned on a portion of the base substrate 210 corresponding to the semiconductor layer 150. The light-shielding layer 220 shields the base substrate 210 from light from the outside. In some embodiments, the light-shielding layer 220 may be not employed in the light-sensing element Rp.

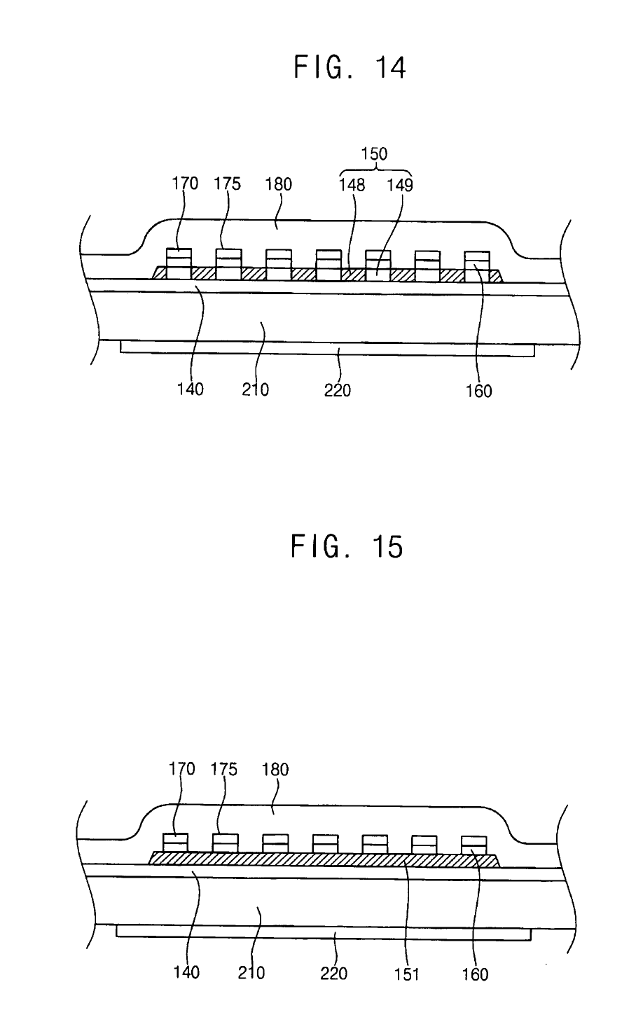

FIGS. 13 and 14 are cross sectional views illustrating a method of manufacturing the light-sensing element Rp in FIG. 12.

Referring to FIG. 13, a transparent layer including photoresist (not shown) is formed on the base substrate 210. The transparent layer is patterned by a photolithographic process including an exposing process and a developing process to form the light-shielding layer 220. Alternatively, the transparent layer may be formed beneath the base substrate 210.

Silicon nitride may be deposited on the base substrate 210 to form the insulation layer 140. An amorphous silicon layer is formed on the insulation layer 140. The amorphous silicon may have a thickness of about 1,000 Å to about 4,000 Å. The amorphous silicon layer is patterned by a photolithographic process to form an amorphous silicon layer pattern.

Impurities are implanted into the amorphous silicon layer pattern to form a preliminary semiconductor layer 150′ and an impurity layer on the preliminary semiconductor layer 150′.

A metal layer is formed on the impurity layer and is patterned by a photolithographic process to form the first and second electrodes 170 and 175.

The impurity layer is etched using the first and second electrodes 170 and 175 as an etching mask to form the ohmic contact layer 160.

An organic material is coated on the preliminary semiconductor layer 150′, the ohmic contact layer 160, the first and second electrodes 170 and 175, and the insulation layer 140 to form the passivation layer 180.

A laser beam from a laser emitter 700 irradiates the preliminary semiconductor layer 150′. Here, to prevent amorphous silicon from being converted into polysilicon, the wavelength, the irradiation time, and the irradiation interval of the laser are closely controlled. In the present embodiment, the laser beam may include a pulse laser beam. The laser may have a wavelength of no less than about 400 nm, an irradiation interval of about 0.5/sec to about 100/sec, a scanning speed of about 10 μm/sec to about 40 μm/sec, and an irradiated cross sectional area of about 50×50 μm² to about 1×1 mm². Also, the amount of energy in a single scan of the laser beam is about 100 mJ/cm² to about 400 mJ/cm², which is about 30 to about 40 times the energy of a light to be measured. Preferably, the laser has a wavelength of about 532 nm, an irradiation interval of about 1/sec to about 50/sec, a scanning speed of about 20 μm/sec, and an irradiated cross sectional area of about 500×500 μm². The amount of energy in a single scan of the laser beam is about 360 mJ/cm², which is about 35 times the energy of the light from a CCFL or an LED to be measured. Alternatively, the energy may be about 33 to about 37 times that of the light.

Referring to FIG. 14, a portion of the preliminary semiconductor layer 150′ (see FIG. 13) between the first and second electrodes 170 and 175 is saturated with light to form the semiconductor layer 150 having stable bonds between amorphous silicon molecules. The semiconductor layer 150 includes the first amorphous silicon layer 148 saturated with light, and the second amorphous silicon layer 149 that is not irradiated with the laser beam. In the present embodiment, the first amorphous silicon layer 148 has an electrical resistance higher than that of the second amorphous silicon layer 149.

Since the semiconductor layer 150 includes a laser-treated portion in the present embodiment, the electrical characteristics of the light-sensing element may be maintained even after the light-sensing element Rp is operated several times.

FIG. 15 is a cross-sectional view illustrating a light-sensing element Rp in accordance with an exemplary embodiment.

The light-sensing element Rp includes elements substantially identical to those in FIG. 12 except for a semiconductor layer 150. Thus, the same reference numerals refer to the same elements and any further descriptions with respect to the same elements are omitted herein.

Referring to FIG. 15, the light-sensing element Rp includes a base substrate 210, an insulation layer 140, a semiconductor layer 151, an ohmic contact layer 160, a first electrode 170, a second electrode 175, a passivation layer 180 and a light-shielding layer 220.

The semiconductor layer 151 is formed on the insulation layer 140. The semiconductor layer 151 includes an amorphous silicon layer saturated with light. In the present embodiment, an entire face of the semiconductor layer 151 is treated with a laser beam so that the semiconductor layer 151 has stable electrical characteristics. That is, the amorphous silicon layer saturated with light is positioned beneath the first and second electrodes 170 and 175 as well as in spaces between the first and second electrodes 170 and 175. Thus, since dangling bonds are previously formed in the semiconductor layer 151 before operating the light-sensing element Rp, the dangling bonds are not formed during the operation of the light-sensing element Rp.

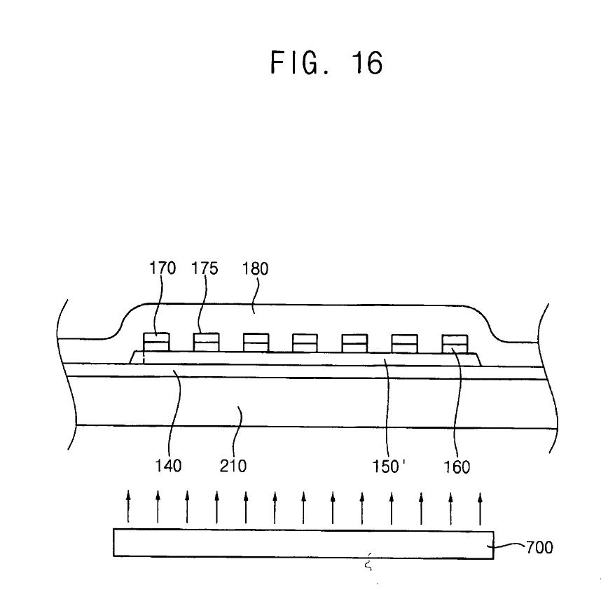

FIGS. 16 to 18 are cross-sectional views illustrating a method of manufacturing the light-sensing element Rp in FIG. 15.

Referring to FIG. 16, the insulation layer 140 is formed on the base substrate 210. An amorphous silicon layer (not shown) is formed on the insulation layer 140. The amorphous silicon layer is patterned by a photolithographic process to form an amorphous silicon layer pattern (not shown).

Impurities are implanted into the amorphous silicon layer pattern to form a preliminary semiconductor layer 150′ and an impurity layer on the preliminary semiconductor layer 150′.

The first and second electrodes 170 and 175 are formed on the impurity layer. The impurity layer is etched using the first and second electrodes 170 and 175 as an etching mask to form the ohmic contact layer 160.

An organic material is coated on the preliminary semiconductor layer 151′, the ohmic contact layer 160, the first and second electrodes 170 and 175, and the insulation layer 140 to form the passivation layer 180. A laser beam from a laser emitter 700 irradiates the preliminary semiconductor layer 150′.

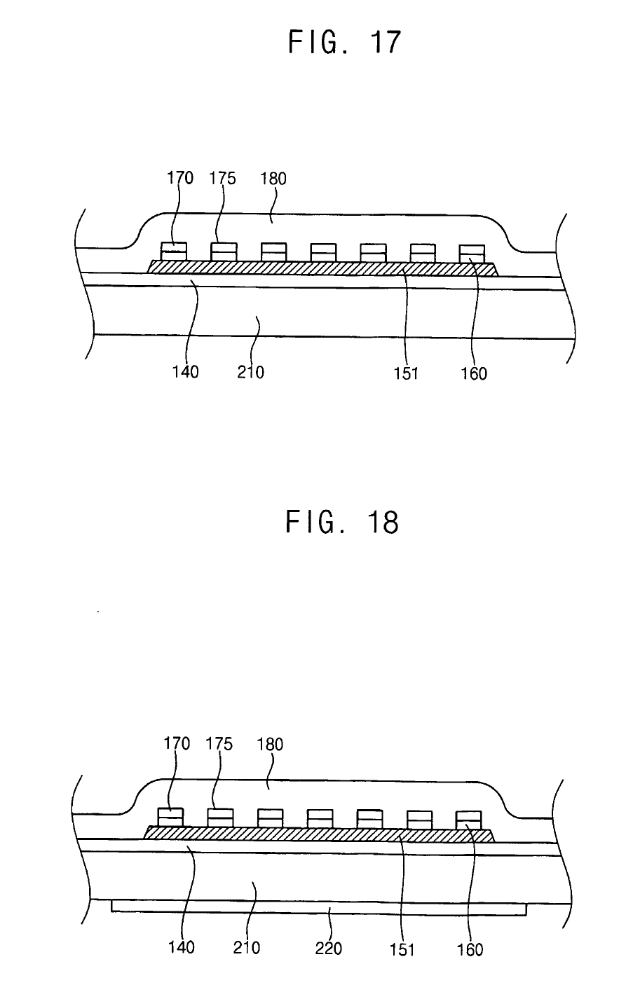

Referring to FIG. 17, the preliminary semiconductor layer 150′ is saturated with light to form the semiconductor layer 151 having stable bonds between amorphous silicon molecules. In the present embodiment, the semiconductor layer 151 has an electrical resistance higher than that of the preliminary semiconductor layer 150′.

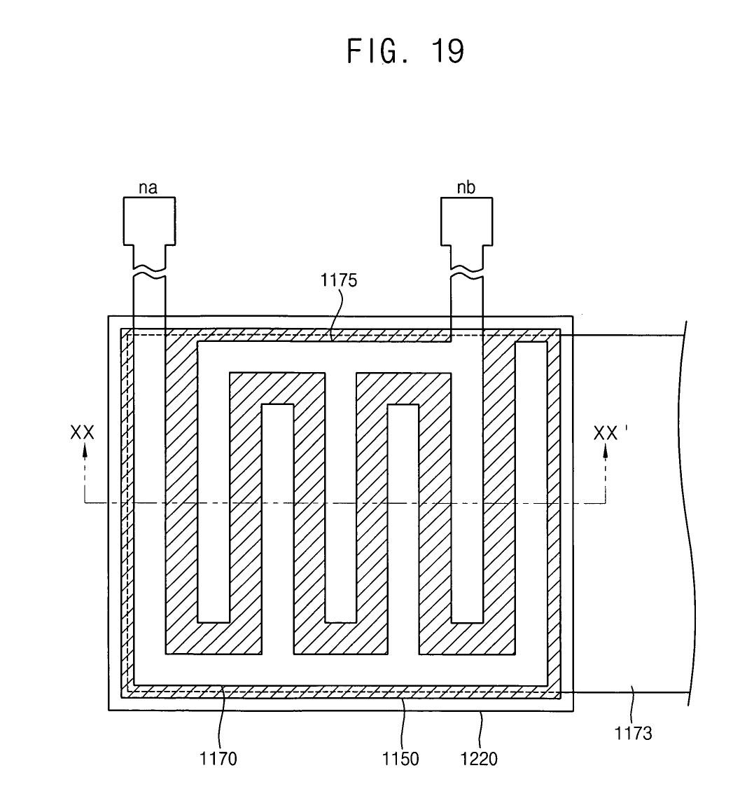

Referring to FIG. 18, the light-shielding layer 220 is formed on the base substrate 210.

Since the semiconductor layer 151 is wholly treated with the laser in the present embodiment, the electrical characteristics of the light-sensing element Rp may be maintained even after operating the light-sensing element Rp several times.

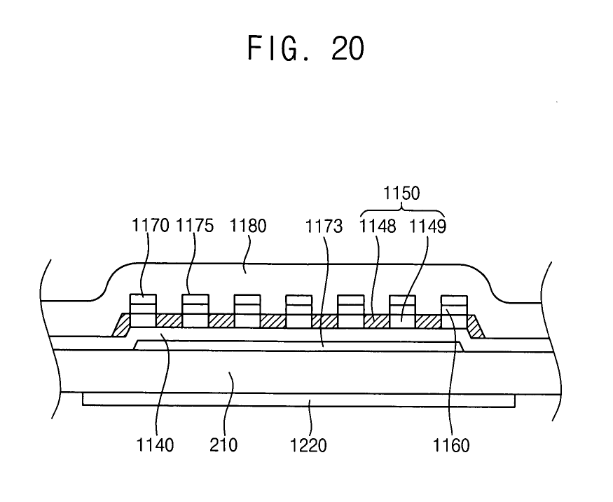

FIG. 19 is a plan view illustrating a thin film transistor (TFT) in accordance with another exemplary embodiment, and FIG. 20 is a cross sectional view taken along line XX-XX′ in FIG. 19.

The TFT includes elements substantially identical to those in FIGS. 11 and 12 except for a control electrode. Thus, any further descriptions with respect to the same elements are omitted herein.

Referring to FIGS. 19 and 20, the TFT includes a base substrate 210, a control electrode 1173, an insulation layer 1140, a semiconductor layer 1150, an ohmic contact layer 1160, a first electrode 1170, a second electrode 1175, a passivation layer 1180 and a light-shielding layer 1220.

The control electrode 1173 includes a conductive material. Also, the control electrode 1173 is placed on the base substrate 210.

The semiconductor layer 1150 is formed on a portion of the insulation layer 1140 corresponding to the control electrode 1173. The semiconductor layer 1150 includes a first amorphous silicon layer 1148 saturated with light, and a second amorphous silicon layer 1149 that is not irradiated. The first amorphous silicon layer 1148 is interposed between the first and second electrodes 1170 and 1175. The second amorphous silicon layer 1149 is positioned beneath the first and second electrodes 1170 and 1175.

In the present embodiment, the laser beam may include a pulse laser beam. The laser beam has a wavelength of no less than about 400 nm, an irradiation interval of about 0.5/sec to about 100/sec, a scanning speed of about 10 μm/sec to about 40 μm/sec, and an irradiated cross sectional area of about 50×50 μm² to about 1×1 mm². Also, the amount of energy in a single scan of the laser beam is about 100 mJ/cm² to about 400 mJ/cm², which is about 30 to about 40 times the energy of light to be measured. Preferably, the laser has a wavelength of about 532 nm, an irradiation interval of about 1/sec to about 50/sec, a scanning speed of about 20 μm/sec, and an irradiated cross-sectional area of about 500×500 μm². Also, the laser beam has a single-scan energy of about 360 mJ/cm² that is about 35 times the energy of a light from a CCFL or an LED. Alternatively, the amount of energy in the laser beam may be about 33 to about 37 times as much as that of the light.

The ohmic contact layer 1160 is formed on the semiconductor layer 1150. The first and second electrodes 1170 and 1175 are placed on the ohmic contact layer 1160. The first and second electrodes 1170 and 1175 are spaced apart from each other.

The passivation layer 1180 is formed on the insulation layer 1140, the semiconductor layer 1150, the ohmic contact layer 1160, and the first and second electrodes 1170 and 1175. The passivation layer 1180 protects the semiconductor layer 1150, the ohmic contact layer 1160 and the first and second electrodes 1170 and 1175 from external impact and foreign substances. Meanwhile, the passivation layer 1180 may include a transparent material.

The light-shielding layer 1220 is positioned on a portion of the base substrate 210 corresponding to the semiconductor layer 1150. The light-shielding layer 1220 shields the base substrate 210 from light coming from an external source. The light-shielding layer 1220 is optional and may be not employed in the light-sensing element Rp in some embodiments.

Since the semiconductor layer 1150 includes a laser-treated portion in the present embodiment, the electrical characteristics of the TFT are maintained even though the TFT is exposed to light from a CCFL.

### EXAMPLE 1

An amorphous silicon layer that was substantially identical to that in FIGS. 11 and 12 was prepared. The amorphous silicon layer had a rectangular shape, a thickness of 2,000 Å, a width of 10 μm, and a length of 9,000 μm.

The amorphous silicon layer was irradiated with a laser beam, and the electrical resistance of the amorphous silicon layer was measured.

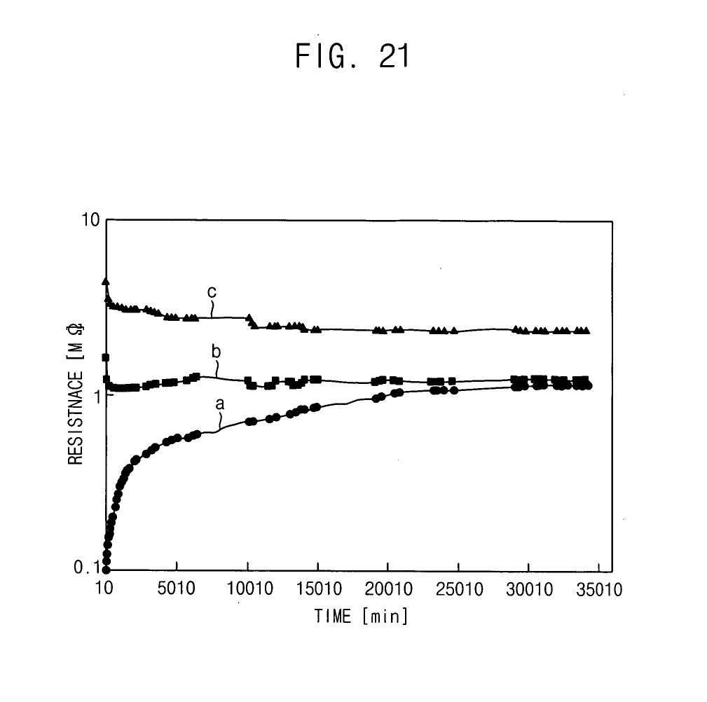

FIG. 21 is a graph showing the measured electrical resistance of the amorphous silicon layer with respect to irradiation time.

In FIG. 21, the line a represents an electrical resistance variation under the following conditions: a laser beam having a single-scan energy of 100 mJ/cm², a wavelength of 532 nm, energy in one shot of 0.6 mJ, an irradiation interval of 27/sec, a scanning speed of 20 μm/sec, and a cross sectional area of 500×500 μm². The line b represents the electrical resistance variation when using a laser beam having a single-scan energy of 360 mJ/cm². As for the line c, it represents an electrical resistance variation when using a laser beam having a single-scan energy of 400 mJ/cm².

As shown in FIG. 21, the electrical resistance of the amorphous silicon layer changes while the amorphous silicon layer is irradiated. Also, the higher the energy of the irradiating laser beam, the more quickly the electrical resistance stabilizes with less transition time. In line a, the electrical resistance stabilized after 20,000 minutes. In line b or c, the electrical resistance stabilized after 10 minutes.

When the energy of the laser beam is high, a lot of energy is consumed. Thus, when the energy of the laser is 360 mJ/cm², the amorphous silicon layer has optical electrical characteristics. Also, the amorphous silicon layer is manufactured in a short time.

### EXAMPLE 2

An amorphous silicon layer that was substantially identical to that in FIGS. 11 and 12 was prepared. A green light having a wavelength of 533 nm and a range of luminance levels, which was emitted from an LED, irradiated the amorphous silicon layer four times.

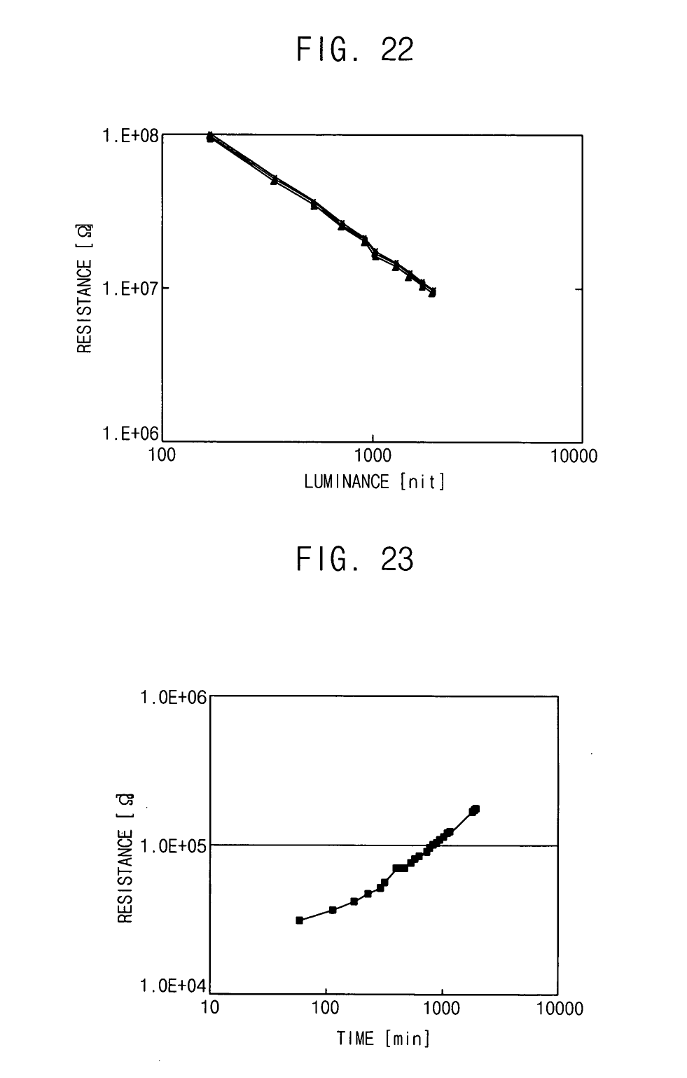

FIG. 22 is a graph illustrating the stability of the amorphous silicon layer after irradiation with a laser beam.

As shown in FIG. 22, when the amorphous silicon layer is exposed several times to the green light, the electrical resistance of the amorphous silicon layer has a deviation of 2%.

### EXAMPLE 3

An amorphous silicon layer that was substantially identical to that in FIGS. 11 and 12 was prepared. The amorphous silicon layer had a rectangular shape, a thickness of 2,000 Å, a width of 10 μm, and a length of 9,000 μm. Light having a luminance of 4,900 nit (or cd/m²) emitted from a CCFL irradiated the amorphous silicon layer for 33 hours.

FIG. 23 is a graph illustrating an electrical resistance of a channel layer in the amorphous silicon layer.

As shown in FIG. 23, a difference between an initial electrical resistance and a final electrical resistance of the amorphous silicon layer is 155 kΩ. In particular, the final electrical resistance is 7 times as much as the initial electrical resistance.

### EXAMPLE 4

An amorphous silicon layer that was substantially identical to that in FIGS. 11 and 12 was prepared. A green light having a wavelength of 533 nm and a range of luminance was emitted by an LED. This green light was used to irradiate the amorphous silicon layer four times.

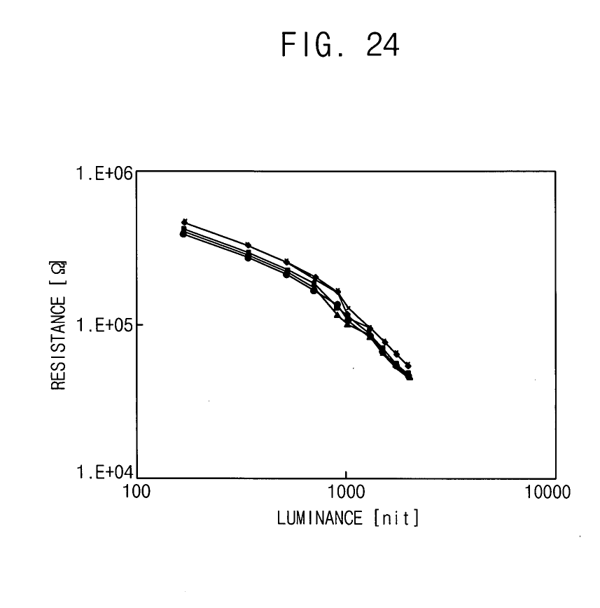

FIG. 24 is a graph illustrating the stability of the amorphous silicon layer after irradiation with a laser beam.

As shown in FIG. 24, when the amorphous silicon layer is exposed several times to the green light, the electrical resistance of the amorphous silicon layer has a deviation of 17.7%.

According to the present invention, the differential signal that is amplified based on the light-sensing part and the reference signal-generating part is produced. The luminance of the light source is controlled using the control signal generated using the analog adder. Thus, luminance variations of the light directed to the LCD panel assembly are met rapidly and sensitively so that the luminance of the light source may be accurately controlled.

Also, the common grounds of the light-sensing part and the reference signal-generating part, and the common buffer resistor between the first and second operational amplifiers may suppress the influences of external noise.

Further, the light-sensing part is directly provided to the LCD panel assembly so that the light emitted from the light source may be precisely measured without an additional photo sensor in the LCD apparatus, thereby decreasing measurement errors.

Furthermore, since the semiconductor layer includes the laser-treated amorphous silicon layer, the electrical characteristics of the light-sensing element may be maintained even after the light-sensing element is exposed to light.

Having described the exemplary embodiments of the present invention and its advantages, it is noted that various changes, substitutions and alterations can be made herein without departing from the spirit and scope of the invention as defined by appended claims.

What is claimed is:

1. An apparatus for controlling a luminance of a light source, comprising:
a light-sensing part generating a detection signal based on a quantity of light emitted from the light source;
a reference signal-generating part generating a reference signal;
a control signal-generating part comparing the detection signal with the reference signal to generate a control signal, the control signal-generating part including an amplification circuit that amplifies a difference between the reference signal and the detection signal by an amplification factor to generate a differential signal, and an analog adder that generates the control signal based on the differential signal and the reference signal;
a backlight-controlling part controlling the luminance of the light source in accordance with the control signal; and
a backlight-driving part providing an electric power to the light source in accordance with controls of the backlight-controlling part.

2. The apparatus of claim 1, wherein the light-sensing part and the reference signal-generating part have a common ground terminal.

3. The apparatus of claim 1, wherein the amplification factor is about two.

4. The apparatus of claim 1, wherein the control signal corresponds to a sum of the reference signal and a difference between the reference signal and the detection signal.

5. The apparatus of claim 1, wherein the backlight-controlling part comprises a pulse width modulator that generates a pulse width modulation signal based on the control signal.

6. The apparatus of claim 1, wherein the amplification circuit comprises:
a first operational amplifier that includes a first non-inverting input terminal receiving the detection signal, a first inverting input terminal, and a first output terminal;
a second operational amplifier that includes a second non-inverting input terminal receiving the reference signal, a second inverting input terminal, and a second output terminal; and
a third operational amplifier that includes a third inverting input terminal electrically connected to the first output terminal, a third non-inverting input terminal electrically connected to the second output terminal, and a third output terminal.

7. The apparatus of claim 6, further comprising:
a first resistor connected between the first and second inverting input terminals;
a second resistor connected between the first inverting input terminal and the first output terminal;
a third resistor connected between the second inverting input terminal and the second output terminal;
a fourth resistor connected between the first output terminal and the third inverting input terminal;
a fifth resistor connected between the second output terminal and the third non-inverting input terminal;
a sixth resistor connected between the third non-inverting input terminal and a ground; and
a seventh resistor connected between the third inverting input terminal and the third output terminal.

8. The apparatus of claim 7, wherein the second to seventh resistors have resistances substantially identical to each other, and the first resistor has a resistance about two times the resistances of the second to seventh resistors.

9. The apparatus of claim 7, wherein the analog adder comprises:
a non-inverting input terminal connected to a ground;
an inverting input terminal;
an output terminal;
an eighth resistor connected between the inverting input terminal of the analog adder and the third output terminal;
a ninth resistor connected between the inverting input terminal of the analog adder and the second non-inverting input terminal; and
a tenth resistor connected between the inverting input terminal and the output terminal of the analog adder.

10. The apparatus of claim 9, wherein the ninth and tenth resistors have resistances substantially identical to each other, and the eighth resistor has a resistance about two times the resistances of the ninth and tenth resistors.

11. The apparatus of claim 10, wherein the second to seventh resistors have resistances substantially identical to each other, and the first resistor has a resistance about two times the resistances of the second to seventh resistors.

12. A liquid crystal display apparatus comprising:
a liquid crystal display panel assembly including a first and second substrates;
a backlight assembly including a light source that provides light to the liquid crystal display panel assembly;
a light-sensing part generating a detection signal based on a quantity of the light irradiating the liquid crystal display assembly;
a reference signal-generating part generating a reference signal;
a control signal-generating part comparing the detection signal with the reference signal to generate a control signal, the control signal-generating part including an amplification circuit that amplifies a difference between the reference signal and the detection signal by an amplification factor to generate a differential signal, and an analog adder that generates the control signal based on the differential signal and the reference signal;
a backlight-controlling part controlling the luminance of the light source in accordance with the control signal; and
a backlight-driving part providing an electric power to the light source in accordance with controls of the backlight-controlling part.

13. The display apparatus of claim 12, wherein the light-sensing part and the reference signal-generating part have a common ground terminal.

14. The display apparatus of claim 12, wherein the amplification factor is about two.

15. The display apparatus of claim 12, wherein the control signal corresponds to a sum of the reference signal and a difference between the reference signal and the detection signal.

16. The display apparatus of claim 12, wherein the backlight-controlling part comprises a pulse width modulator that generates a pulse width modulation signal based on the control signal.

17. The display apparatus of claim 12, wherein the amplification circuit comprises:
a first operational amplifier that includes a first non-inverting input terminal receiving the detection signal, a first inverting input terminal, and a first output terminal;
a second operational amplifier that includes a second non-inverting input terminal receiving the reference signal, a second inverting input terminal, and a second output terminal; and
a third operational amplifier that includes a third inverting input terminal electrically connected to the first output terminal, a third non-inverting input terminal electrically connected to the second output terminal, and a third output terminal.

18. The display apparatus of claim 17, further comprising:
a first resistor connected between the first and second inverting input terminals;
a second resistor connected between the first inverting input terminal and the first output terminal;
a third resistor connected between the second inverting input terminal and the second output terminal;
a fourth resistor connected between the first output terminal and the third inverting input terminal;
a fifth resistor connected between the second output terminal and the third non-inverting input terminal;
a sixth resistor connected between the third non-inverting input terminal and a ground; and
a seventh resistor connected between the third inverting input terminal and the third output terminal.

19. The display apparatus of claim 18, wherein the second to seventh resistors have resistances substantially identical to each other, and the first resistor has a resistance about two times the resistances of the second to sixth resistors.

20. The display apparatus of claim 18, wherein the analog adder comprises:
a non-inverting input terminal connected to a ground;
an inverting input terminal;
an output terminal;
an eighth resistor connected between the inverting input terminal of the analog adder and the third output terminal;
a ninth resistor connected between the inverting input terminal of the analog adder and the second non-inverting input terminal; and
a tenth resistor connected between the inverting input terminal and the output terminal of the analog adder.

21. The display apparatus of claim 20, wherein the ninth and tenth resistors have resistances substantially identical to each other, and the eighth resistor has a resistance about two times the resistances of the ninth and tenth resistors.

22. The display apparatus of claim 12, wherein the light-sensing part is integrated with the liquid crystal display assembly.

23. The display apparatus of claim 22, wherein the light-sensing part comprises at least two parts that are positioned in regions of the liquid crystal display assembly different from each other.

24. The display apparatus of claim 12, wherein the light source comprises light emitting diodes.

25. The display apparatus of claim 24, wherein each of the light emitting diodes comprises at least one selected from the group consisting of red, green and blue light emitting diodes.

26. The display apparatus of claim 25, wherein the light-sensing part senses a red light, a green light or a blue light.

27. The display apparatus of claim 12, wherein the light-sensing part comprises a light-sensing element having a semiconductor layer on the first substrate and at least two electrodes spaced apart from each other on the semiconductor layer.

28. The display apparatus of claim 27, wherein the light-sensing element further comprises a light-shielding layer on one of the first substrate and the second substrate so that the light-shielding layer prevents the semiconductor layer from being exposed to external light.

29. A light-sensing element comprising:
a base substrate;
a semiconductor layer formed on the base substrate, the semiconductor layer including an amorphous silicon layer that is treated with a laser beam;
a first electrode formed on a first portion of the semiconductor layer; and
a second electrode formed on a second portion of the semiconductor layer, the second electrode being spaced apart from the first electrode.

30. The light-sensing element of claim 29, wherein the amorphous silicon layer comprises hydrogenated amorphous silicon.

31. The light-sensing element of claim 29, wherein the amorphous silicon layer is interposed between the first and second electrodes.

32. The light-sensing element of claim 29, wherein the amorphous silicon layer is arranged between the first and second electrodes and beneath the first and second electrodes.

33. The light-sensing element of claim 29, wherein the laser beam irradiating the amorphous silicon layer has an energy about 30 to about 40 times as much as that of light to be measured by the light-sensing element.

34. The light-sensing element of claim 29, wherein the first and second electrodes are arranged in an alternating manner.

35. The light-sensing element of claim 34, wherein the first and second electrodes comprise a transparent conductive material.

36. The light-sensing element of claim 29, further comprising an insulation layer interposed between the base substrate and the semiconductor layer.

37. The light-sensing element of claim 36, further comprising a light-shielding layer beneath the base substrate.

38. A light-sensing element comprising:
a first electrode;
a second electrode spaced apart from the first electrode; and
an amorphous silicon layer including a first portion that makes contact with the first and second electrodes, and a second portion that is interposed between the first and second electrodes, the first and second portions having resistances different from each other.

39. The light-sensing element of claim 38, wherein the amorphous silicon layer comprises hydrogenated amorphous silicon.

40. The light-sensing element of claim 38, wherein the first and second electrodes are arranged in an alternating manner.

41. The light-sensing element of claim 38, wherein the first and second electrodes comprise a transparent conductive material.

42. The light-sensing element of claim 38, further comprising a base
substrate on which the amorphous silicon layer is formed,
wherein the first and second electrodes are formed on the amorphous silicon layer.

43. The light-sensing element of claim 42, further comprising a light-shielding layer beneath the base substrate.

44. A thin film transistor comprising:
a base substrate;
a control electrode formed on the base substrate;
an insulation layer formed on the control electrode;
a semiconductor layer formed on a portion of the insulation layer corresponding to the control electrode, the semiconductor layer including an amorphous silicon layer that is treated with a laser beam;
a first electrode formed on a first portion of the semiconductor layer; and
a second electrode formed on a second portion of the semiconductor layer, the second electrode being spaced apart from the first electrode.

45. The thin film transistor of claim 44, wherein the amorphous silicon layer comprises hydrogenated amorphous silicon.

46. The thin film transistor of claim 44, wherein the laser beam irradiating the amorphous silicon layer has energy about 33 to about 37 times that of light to be measured by the light-sensing element.

47. The thin film transistor of claim 44, wherein the laser comprises a pulse laser.

48. An apparatus for controlling a luminance of a light source, comprising:
a light-sensing part operable to generate a detection signal based on a quantity of light emitted from the light source;
a reference signal-generating part operable to generate a reference signal;
a control signal-generating part operable to compare the detection signal with the reference signal to generate a control signal;
a backlight-controlling part operable to control the luminance of the light source in response to the control signal; and
a backlight-driving part operable to provide an electric power to the light source in accordance with controls of the backlight-controlling part.
